(19) United States
(12) Patent Application Publication
(10) Pub. No.: US 2016/0364039 A1
(43) Pub. Date: Dec. 15, 2016

(54) OPTICAL FILM, DISPLAY PANEL, AND DISPLAY DEVICE

(71) Applicant: Panasonic Intellectual Property Management Co., Ltd., Osaka (JP)

(72) Inventors: Kazuhiro YAMADA, Osaka (JP); Takashi YAMADA, Osaka (JP)

(21) Appl. No.: 15/250,084

(22) Filed: Aug. 29, 2016

Related U.S. Application Data
(63) Continuation of application No. PCT/JP2015/000004, filed on Jan. 5, 2015.

(30) Foreign Application Priority Data
Mar. 20, 2014 (JP) 2014-057468

(51) Int. Cl. G06F 3/042; G06F 3/03; G06F 3/0354; G02F 1/1333

(52) U.S. Cl. CPC G06F 3/042; G02F 1/13338; G06F 3/0321; G06F 3/03542; G02F 1/133514

(57) ABSTRACT

An object is to increase color variations of a bezel part of an optical film while maintaining accuracy of reading position information patterns in the bezel part by a reader. An optical film in accordance with the present disclosure includes: a display part; and a bezel part formed around the display part, wherein each of the display part and the bezel part has formed therein patterns indicating position information, and wherein an area occupied by the patterns per a unit area in the bezel part is smaller than an area occupied by the patterns per a unit area in the display part.

### BACKGROUND

1. Technical Field

The present disclosure relates to an optical film, a display panel, and a display device.

2. Description of Related Art

As disclosed, for example, in Unexamined Japanese Patent Publication No. 2012-243201, such a technique is known that uses a pen-type device to read a position information pattern indicating a coordinate on a plane of a display device.

### SUMMARY

A screen of a display device includes a display part for displaying an image or the like, and a bezel part surrounding the display part. It has been required to increase the color variations of the bezel part while maintaining the accuracy of reading the position information pattern in the bezel part with a reader.

An object of the present disclosure is to increase the color variations of the bezel part while maintaining the accuracy of reading the position information pattern in the bezel part with a reader.

An optical film in accordance with the present disclosure includes: a display part; and a bezel part formed around the display part, wherein each of the display part and the bezel part has formed therein patterns indicating position information, and wherein an area occupied by the patterns per a unit area in the bezel part is smaller than an area occupied by the patterns per a unit area in the display part.

According to the present disclosure, the position information patterns in the bezel part can be made less noticeable. Consequently, it is possible to increase the color variations of the bezel part while maintaining the accuracy of reading the position information patterns in the bezel part by a reader.

### BRIEF DESCRIPTION OF DRAWINGS

FIG. 1 is an external view of a display control system in accordance with a first exemplary embodiment.

FIG. 2 is a block diagram of the display control system in accordance with the first exemplary embodiment.

FIG. 3 is a cross-sectional view taken along line 3-3 of a display panel shown in FIG. 1.

FIG. 4 is an enlarged view of dot patterns in accordance with the first exemplary embodiment.

FIG. 5A is a first diagram for explaining a dot arrangement pattern in accordance with the first exemplary embodiment.

FIG. 5B is a second diagram for explaining a dot arrangement pattern in accordance with the first exemplary embodiment.

FIG. 5C is a third diagram for explaining a dot arrangement pattern in accordance with the first exemplary embodiment.

FIG. 5D is a fourth diagram for explaining a dot arrangement pattern in accordance with the first exemplary embodiment.

FIG. 6 is a diagram for explaining dot patterns and unit areas in accordance with the first exemplary embodiment.

FIG. 7 is an enlarged view of a dotted rectangle shown in FIG. 1.

FIG. 8 is a flowchart for explaining an operation of a digital pen in accordance with the first exemplary embodiment.

FIG. 9 is a flowchart for explaining an operation of a display device in accordance with the first exemplary embodiment.

FIG. 10A is a first diagram for explaining a pixel block pattern in accordance with the first exemplary embodiment.

FIG. 10B is a second diagram for explaining a pixel block pattern in accordance with the first exemplary embodiment.

FIG. 10C is a third diagram for explaining a pixel block pattern in accordance with the first exemplary embodiment.

FIG. 10D is a fourth diagram for explaining a pixel block pattern in accordance with the first exemplary embodiment.

### DETAILED DESCRIPTION

Hereinafter, an exemplary embodiment will be described in detail with reference to the accompanying drawings as appropriate. However, unnecessarily detailed description may occasionally be omitted. For example, detailed description of well-known matters and redundant description of substantially the same configuration may occasionally be omitted. This is to avoid the following description from becoming unnecessarily redundant, and to allow any person skilled in the art to easily understand the description.

Also, it should be noted that the following description and the accompanying drawings are provided to allow any person skilled in the art to fully understand the present disclosure, and that it is not intended to limit the subject matter described in the claims by the following description and the accompanying drawings.

### First Exemplary Embodiment

### 1. Configuration of Display Control System

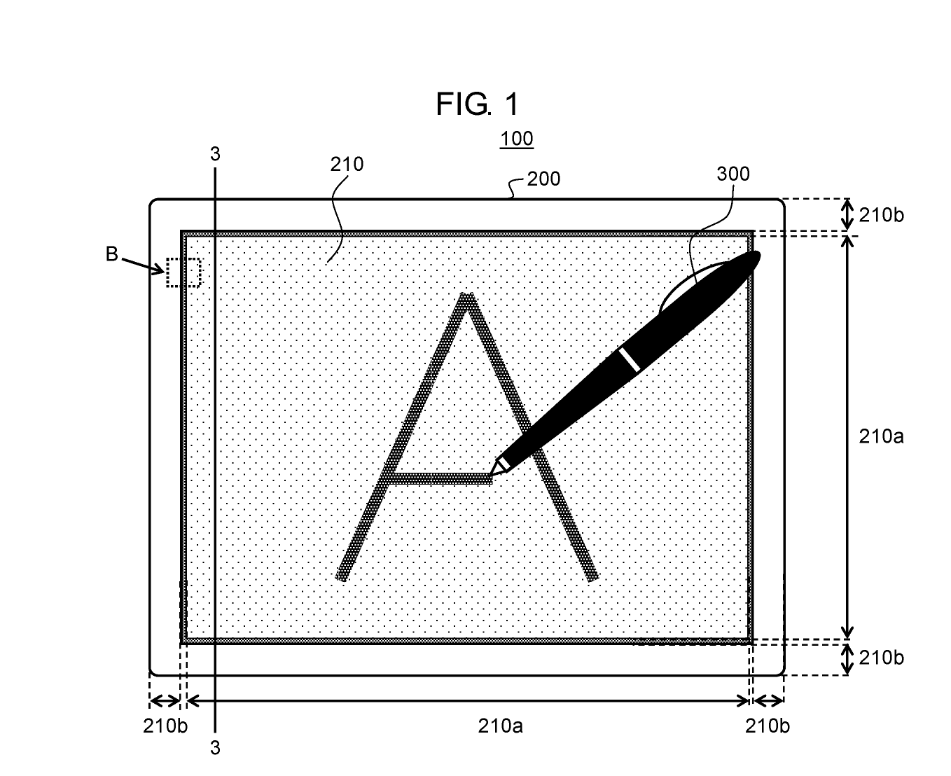

FIG. 1 is an external view of display control system 100 in accordance with a first exemplary embodiment. Display control system 100 includes display device 200, and optical digital pen (digital pen, hereafter) 300. Display device 200 includes display panel 210. Display panel 210 is divided, on the surface, to display part 210a for displaying an image or the like, and bezel part 210b surrounding display part 210a. Referring to FIG. 1, a gap of a specified distance is formed at the border between display part 210a and bezel part 210b.

However, any gap may not be provided at the border between display part 210a and bezel part 210b.

Dot patterns indicating information about positions on display panel 210 are provided in each of display part 210a and bezel part 210b of display panel 210. Digital pen 300 optically reads one of the dot patterns with a pen nib to detect information about a position on display panel 210 (position information, hereafter) at a position of the pen nib of digital pen 300. Digital pen 300 is connected to display device 200 through radio communication, and transmits the detected position information to display device 200. This allows display device 200 to recognize the position information of the pen nib of digital pen 300, and to perform various display controls.

As an example of the display controls, a case of moving the pen nib of digital pen 300 on display panel 210 will be described. In this case, digital pen 300 detects, as a locus of the pen nib of digital pen 300, continuous position information from continuously read dot patterns. Digital pen 300 sequentially transmits the detected position information to display device 200. This allows display device 200 to continuously display dots on display panel 210 according to the locus of the pen nib of digital pen 300. A user can use this function to enter a handwritten character, graphics or the like on display panel 210 with digital pen 300.

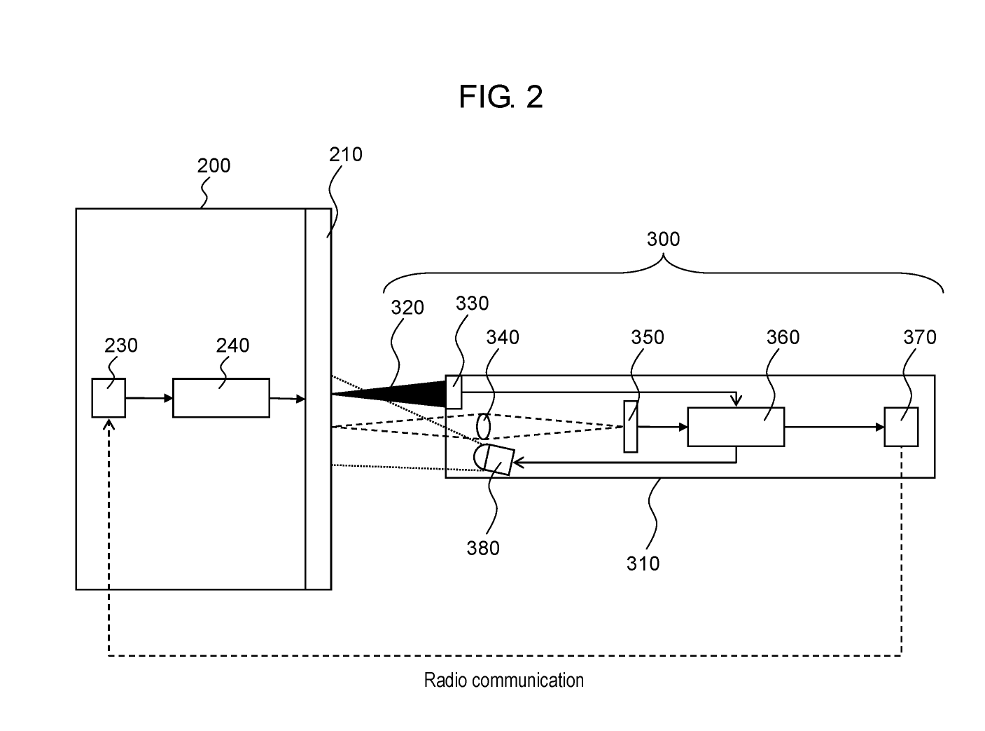

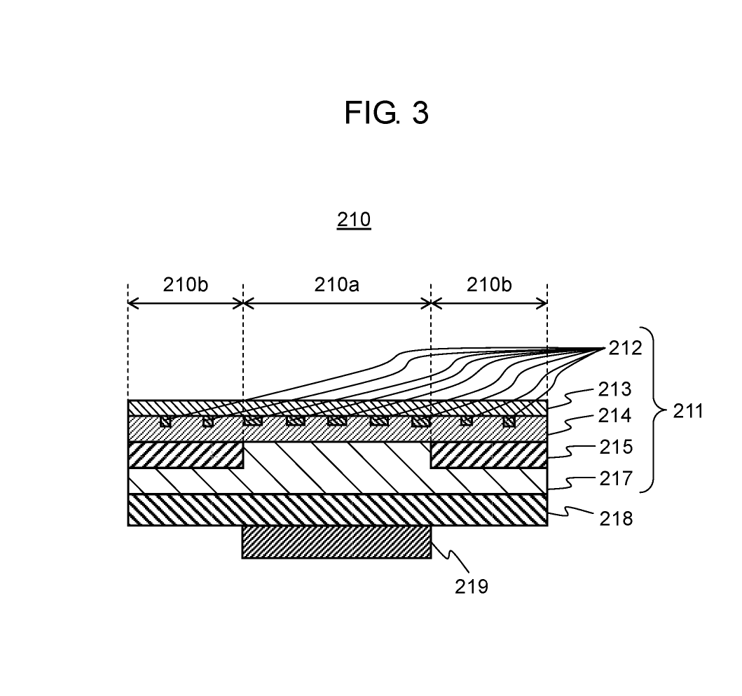

Next, a configuration of display control system 100 will be described. FIG. 2 is a block diagram of display control system 100 in accordance with the first exemplary embodiment, and FIG. 3 is a cross-sectional view taken along line 3-3 of display panel 210 shown in FIG. 1.

Referring to FIG. 2, display device 200 includes display panel 210, receiver 230, and display-side microcomputer 240. Display device 200 may include other electrical configurations, which are omitted herein.

Receiver 230 receives a signal transmitted from digital pen 300. Receiver 230 transmits the received signal to display-side microcomputer 240.

Display-side microcomputer 240 may be configured, for example, by a CPU (central processing unit), a memory, and the like. A program for operating the CPU is installed in display-side microcomputer 240. Display-side microcomputer 240 controls the contents to be displayed on display panel 210 based on the signal transmitted from digital pen 300 to receiver 230 through radio communication.

Next, a configuration of display panel 210 will be described in detail. As shown in FIG. 3, display panel 210 includes optical film 211, touch sensor glass 218, and liquid crystal panel 219.

Optical film 211 includes, in order from a front surface, PET (polyethylene terephthalate) film 213 as a substrate, dot patterns composed of a plurality of dots 212, dot planarization layer 214, bezel decoration layer 215, and decoration planarization layer 217.

PET film 213 protects the front surface of display panel 210, and also functions as a substrate for laminating other layers such, for example, as the layer of dots 212.

A layer of the plurality of dots 212 is laminated on a back surface, or the lower surface in FIG. 3, of PET film 213. Each of the plurality of dots 212 is protruded from the back surface of PET film 213 by an amount corresponding to a thickness of each dot 212. One dot pattern is formed by a plurality of dots 212 contained in a unit area of PET film 213. Dots 212 are made of a material that absorbs infrared light, i.e., a material that has a low transmittance in an infrared region.

Dot planarization layer 214 is laminated on the back surface of PET film 213 so as to fill the spaces between adjacent dots 212. In other words, dot planarization layer 214 is formed to cover the back surface of PET film 213 and the plurality of dots 212. Dot planarization layer 214 is formed to cover the entire back surface of PET film 213. A back surface of the dot planarization layer 214 is a planar surface. Dot planarization layer 214 is made of a material that transmits both visible light and infrared light. For example, dot planarization layer 214 may be made of an acrylic resin.

Bezel decoration layer 215 is laminated in bezel part 210b on a back surface, or the lower surface in FIG. 3, of a peripheral part of dot planarization layer 214. Bezel decoration layer 215 is composed of a single material or a mixture of two or more materials that causes diffuse reflection of infrared light. For example, in a case where the color of the bezel surface is white, bezel decoration layer 215 may be made of a white pigment such as titanium oxide, titanium dioxide or the like, that reflects visible light to exhibit white color and also reflects infrared light.

Bezel decoration layer 215 may be configured by a plurality of layers.

Decoration planarization layer 217 is laminated to bury the step differences formed by bezel decoration layer 215 on a back surface of dot planarization layer 214. Decoration planarization layer 217 is formed over the entire back surface of dot planarization layer 214. A back surface of decoration planarization layer 217 is a planar surface. Decoration planarization layer 217 is made of a material that transmits both visible light and infrared light. Decoration planarization layer 217 may be made, for example, of an acrylic resin.

Touch sensor glass 218 is a glass with a sensor that detects a pressure caused by a user's touch operation. Touch sensor glass 218 is disposed on the back surface, or the lower surface in FIG. 3, of decoration planarization layer 217.

Liquid crystal panel 219 includes a color filter, a liquid crystal layer, and the like. A back light source (not shown) that emits light for irradiating liquid crystal panel 219 is disposed on a back surface of liquid crystal panel 219. Liquid crystal panel 219 applies voltages for changing alignment of liquid crystals in a liquid crystal layer based on a display control by display-side microcomputer 240. This causes liquid crystal panel 219 to control the transmission amount of the light from the back light source to perform various display operations.

Next, a configuration of digital pen 300 will be described.

Digital pen 300 has an external appearance similar to those of hand-writing pens. Referring to FIG. 2, digital pen 300 includes cylindrical body case 310, and pen nib 320 mounted on an end of body case 310. Digital pen 300 further includes, within body case 310, pressure sensor 330, objective lens 340, image sensor 350, pen-side microcomputer 360, transmitter 370, and irradiator 380.

Body case 310 is cylindrical. Pen nib 320 has a tapered shape. A tip of pen nib 320 is rounded so as not to scratch the surface of display panel 210.

The shape of pen nib 320 may be such that the user can easily apply a pressure to digital pen 300 while recognizing an image displayed on display panel 210.

Pressure sensor 330 is mounted in body case 310, and coupled to the base end of pen nib 320. Pressure sensor 330 detects a pressure applied to pen nib 320. Specifically, when the user writes a character or the like on display panel 210 with digital pen 300, pressure sensor 330 detects a pressure applied to pen nib 320 from display panel 210. Pressure sensor 330 is used, for example, to determine an occurrence of a user's input operation with digital pen 300. A pressure detection result by pressure sensor 330 is informed to pen-side microcomputer 360.

Irradiator 380 is disposed in the vicinity of pen nib 320 in body case 310. Irradiator 380 is configured, for example, by an infrared LED (light emitting diode). Irradiator 380 is disposed so as to emit infrared light from pen nib 320 mounted on body case 310.

Objective lens 340 focus light rays entered from pen nib 320 on image sensor 350. Objective lens 340 is disposed in the vicinity of pen nib 320 in body case 310. When infrared light is emitted from irradiator 380 in a condition that pen nib 320 of digital pen 300 is pointing at display part 210a or bezel part 210b of display device 200, the infrared light transmits through display panel 210, and is diffusely reflected by liquid crystal panel 219 or bezel decoration layer 215 which are located at the back side of display panel 210. As a result, a part of the infrared light having passed through display panel 210 comes back to digital pen 300. A part of the infrared light emitted from irradiator 380 and diffusely reflected by display device 200 enters objective lens 340. Image sensor 350 is disposed on an optical axis of objective lens 340. Accordingly, the infrared light passed through objective lens 340 is focused on an imaging plane of image sensor 350.

Image sensor 350 converts an optical image formed on the imaging plane to an electrical signal, or an image signal, and outputs the image signal to pen-side microcomputer 360. Image sensor 350 is configured, for example, by a CCD (charge coupled device) image sensor or a CMOS (complementary metal oxide semiconductor) image sensor. Dots 212 configuring the dot patterns are made of a material that absorbs infrared light, i.e., a material that has a low transmittance in an infrared region. Accordingly, almost no infrared light comes back to digital pen 300 from dots 212 configuring the dot patters. On the other hand, larger amount of infrared rays come back from regions between dots 212 than the regions of dots 212. Consequently, image sensor 350 captures such an optical image that contains a dot pattern appearing in black.

Pen-side microcomputer 360 identifies position information of digital pen 300 on display panel 210 based on the image signal produced by image sensor 350 from the captured image. Specifically, pen-side microcomputer 360 acquires a pattern shape of a dot pattern from the image signal produced by image sensor 350 from the captured image, and identifies a position of pen nib 320 on display panel 210 based on the pattern shape. Pen-side microcomputer 360 is configured by a CPU, a memory and the like. A program for operating the CPU is stored in the memory.

Transmitter 370 transmits a signal to the outside. Specifically, transmitter 370 transmits the position information identified by pen-side microcomputer 360 to receiver 230 of display device 200, which is a destination of radio communication.

### 2. Dot Patterns

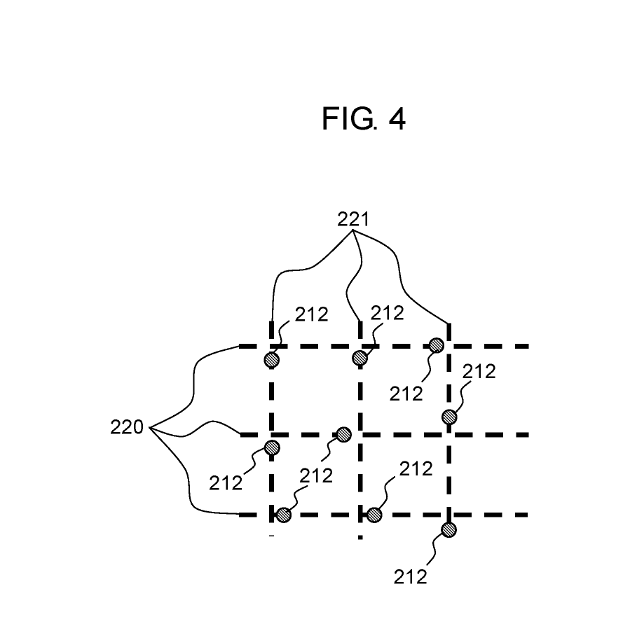

Next, the dot patterns will be described in detail. FIG. 4 is an enlarged view of dot patterns in accordance with the first exemplary embodiment. FIG. 4 shows an enlarged view of the dot patterns seen from the side of PET film 213 of optical film 211. Referring to FIG. 4, first reference lines 220 and second reference lines 221 are drawn on optical film 211, as virtual lines that do not actually exist on optical film 211, to explain positions of dots 212 in the dot patterns. Each of first reference lines 220 and each of second reference lines 221 are perpendicular to each other, so that a grid is formed by first reference lines 220 and second reference lines 221.

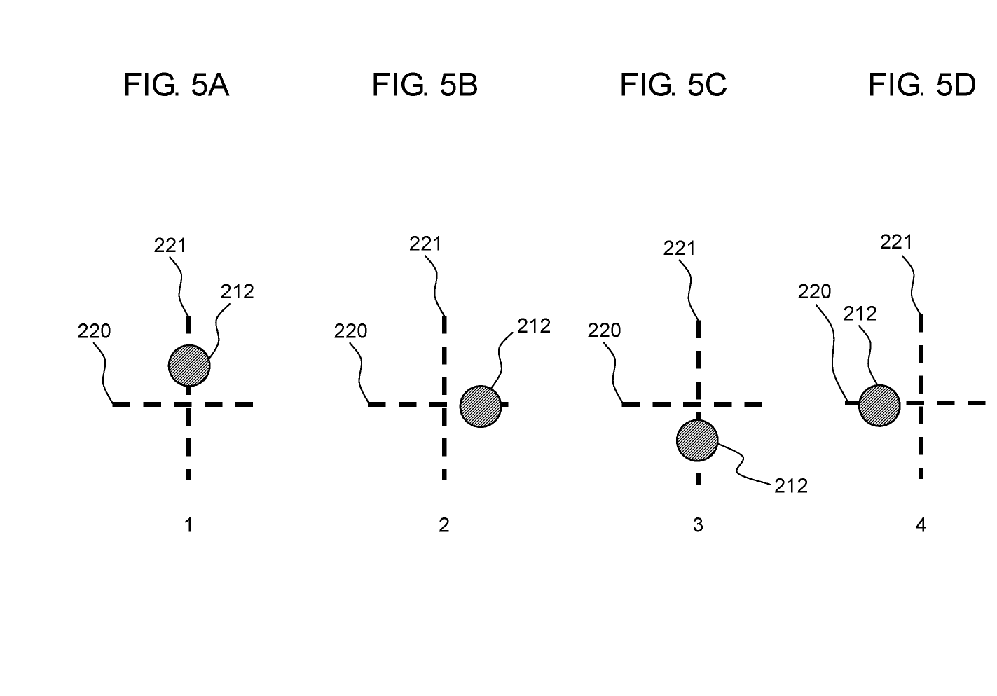

Each of dots 212 is disposed at a position around an intersection of one first reference line 220 and one second reference line 221. In other words, each dot 212 is disposed near a grid point. FIG. 5A is a first diagram for explaining a arrangement pattern of dot 212, FIG. 5B is a second diagram for explaining a arrangement pattern of dot 212, FIG. 5C is a third diagram for explaining a arrangement pattern of dot 212, and FIG. 5D is a fourth diagram for explaining a arrangement pattern of dot 212. Referring to FIG. 5A, FIG. 5B, FIG. 5C and FIG. 5D, supposing that the extending direction of first reference lines 220 be an X-direction and the extending direction of second reference lines 221 be a Y-direction, each dot 212 is disposed at a position offset toward a positive side or a negative side along the X-direction or the Y-direction from an intersection of one first reference line 220 and one second reference line 221. Specifically, in optical film 211, each dot 212 is disposed at either one of the positions shown in FIG. 5A, FIG. 5B, FIG. 5C and FIG. 5D. In the arrangement pattern shown in FIG. 5A, dot 212 is disposed at a position above an intersection of first reference line 220 and second reference line 221. This position is numerically expressed as “1”. In the arrangement pattern shown in FIG. 5B, dot 212 is disposed at a position on the right of an intersection of first reference line 220 and second reference line 221. This position is numerically expressed as “2”. In the arrangement pattern shown in FIG. 5C, dot 212 is disposed at a position below an intersection of first reference line 220 and second reference line 221. This position is numerically expressed as “3”. In the arrangement pattern shown in FIG. 5D, dot 212 is disposed at a position on the left of an intersection of first reference line 220 and second reference line 221. This position is numerically expressed as “4”. As described above, each dot 212 can be expressed by one of numerals “1” to “4” according to its arrangement pattern.

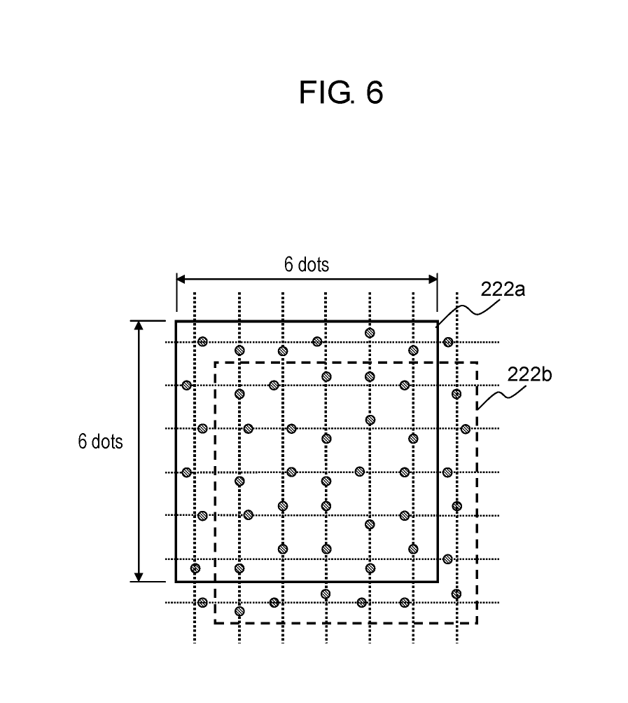

FIG. 6 is a diagram for explaining dot patterns and unit areas. Referring to FIG. 6, one unit area 222a or 222b configured by vertical 6 dots by horizontal 6 dots is defined so that 36 dots 212 contained in each unit area form one dot pattern. Dot patterns that have different information from each other can be formed by disposing each of 36 dots 212 contained in each of unit areas 222a and 222b at either one of positions “1” to “4” shown in FIG. 5A to FIG. 5D. In optical film 211, the dot patterns in unit area 222a and unit area 222b are different patterns from each other. In this manner, the dot patterns in all unit areas are formed so as to have different patterns from one another.

The dot pattern in each unit area in optical film 211 indicates coordinates of a position. Referring to FIG. 6, the dot pattern in unit area 222a indicates coordinates of a center position in unit area 222a, and the dot pattern in unit area 222b indicates coordinates of a center position in unit area 222b. In a case where pen nib 320 moves obliquely toward a lower right direction in FIG. 6, the unit area read by digital pen 300 changes from unit area 222a to unit area 222b. A change in coordinates of each position can be calculated by this movement across the unit areas.

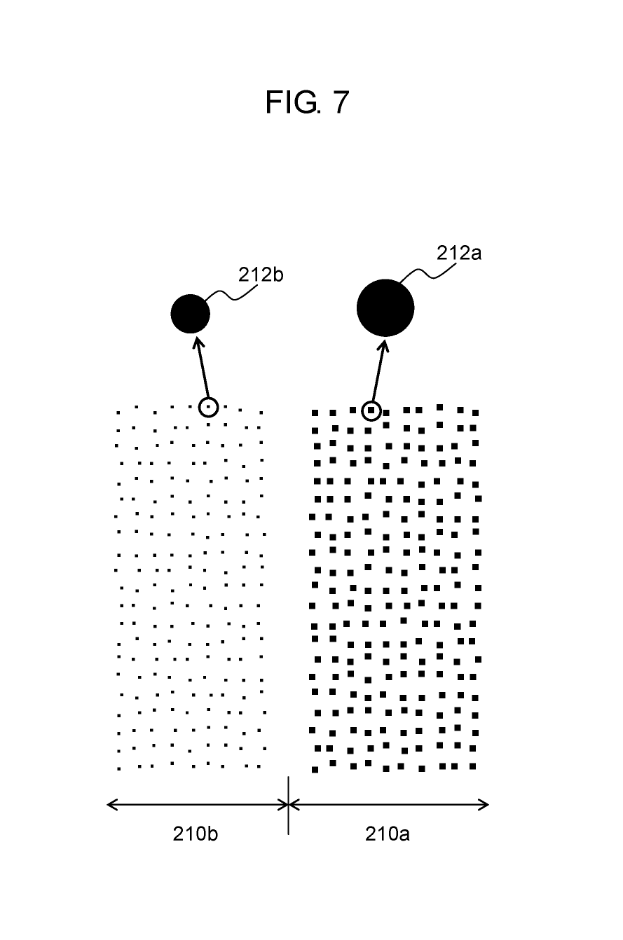

Next, sizes of dots 212 in display part 210a and in bezel part 210b of display panel 210 will be described. FIG. 7 is an enlarged view of dotted rectangle B shown in FIG. 1. The sizes of the dots in display part 210a and the dots in bezel part 210b will be described with reference to FIG. 7. Referring to FIG. 7, while the area of each unit area is kept constant and the distance between adjacent dots is kept constant, i.e., the size of the grid described with reference to FIG. 4 is kept the same, the size of each dot 212a in display part 210a is made different from the size of each dot 212b in bezel part 210b. Specifically, when a size of each dot 212a in display part 210a and a size of each dot 212b in bezel part 210b are compared to each other, the size of each dot 212a in display part 210a is made larger than the size of each dot 212b in bezel part 210b. Display part 210a of display panel 210 displays an image that is output from liquid crystal panel 219. Liquid crystal panel 219 has color filters, such, for example, as R (red) color filters, G (green) color filters and B (blue) color filters, for producing a color image. A grid structure having a specific line width, called a black matrix, is provided between the color filters to secure color accuracy. The size of each dot 212a in display part 210a is made adequately, at least three times for example, larger than the line width of the black matrix of liquid crystal panel 219. For example, if the line width of the black matrix is 40μ, the size of each dot 212a in display part 210a may be made 125μ. This makes it possible to prevent the dot pattern from being buried in the black matrix even when the black matrix and the dot pattern overlap each other on the irradiation path of the infrared light from digital pen 300, and to secure the reading accuracy with pen nib 320.

On the other hand, no black matrix exists in bezel part 210b. In other words, it is not necessary to consider in bezel part 210b that a black matrix and the dot pattern overlap each other on the irradiation path of the infrared light from digital pen 300. Therefore, it is not necessary to consider the size of each dot 212 in bezel part 210b. Also, if the size of each dot 212 in bezel part 210b is increased, the dot patterns are visually observed because of the non-existence of the black matrix, so that color shift or color non-uniformity of the bezel color occurs, and deteriorates quality of appearance. Particularly, in a case where the bezel color is white or light color, deterioration of quality of appearance becomes remarkable. For this reason, the size of each dot 212b in bezel part 210b is made about 80μ. In bezel part 210b, in which no black matrix exists, the dot size can be made smaller than that in display part 210a while maintaining the accuracy of reading with digital pen 300, so that the color shift and color non-uniformity can be considerably reduced.

In optical film 211, as described above, the size of each of dots 212b forming each dot pattern in bezel part 210b is made smaller than the size of each of dots 212a forming each dot pattern in display part 210a. This allows the position information pattern in bezel part 210b to be less noticeable, so that the color variations of bezel part 210b can be increased while maintaining the accuracy of reading the position information pattern in bezel part 210b with digital pen 300 as a reader.

### 3. Display Operation

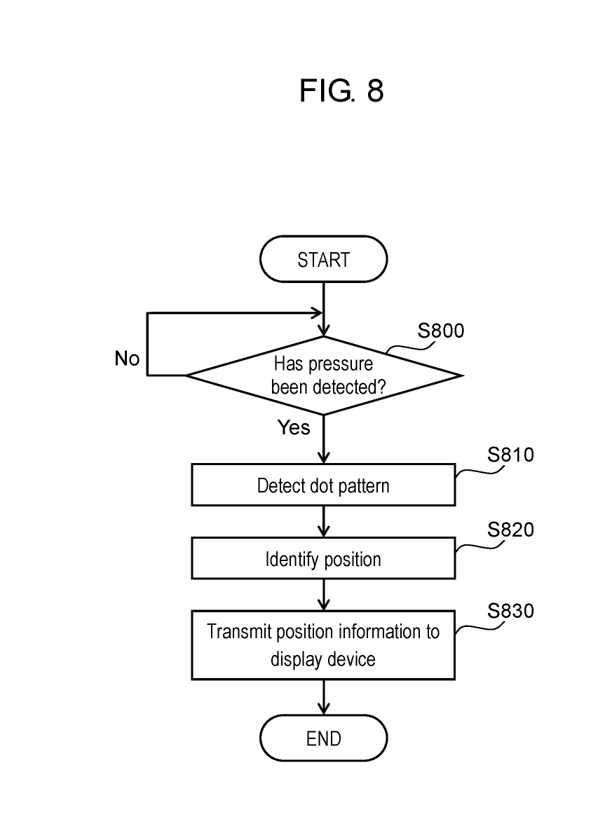

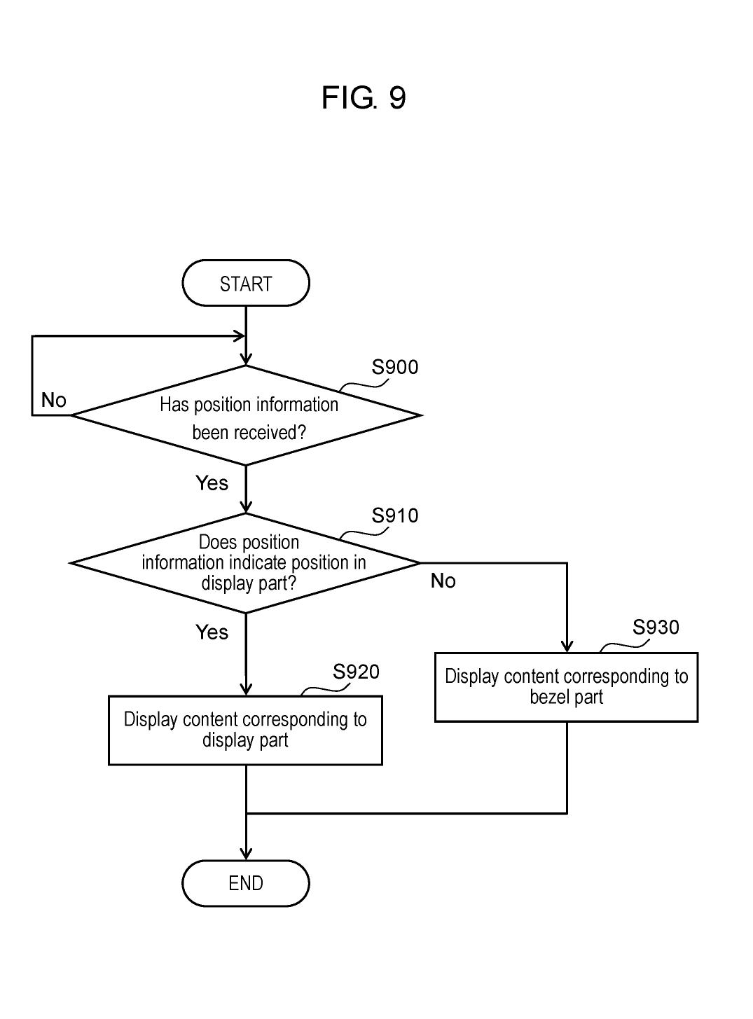

Next, a display operation of display control system 100 will be described with reference to FIG. 8 and FIG. 9. FIG. 8 is a flowchart for explaining an operation of digital pen 300 in accordance with the present exemplary embodiment, and FIG. 9 is a flowchart for explaining an operation of display device 200 in accordance with the present exemplary embodiment. Description will be made on a case that a user uses digital pen 300 to input a character to display device 200.

First, display device 200 and digital pen 300, that configure display control system 100, are powered on. This allows display-side microcomputer 240 to be supplied with power from a power source (not shown), and to complete an initial operation for executing various operations. Similarly, pen-side microcomputer 360 is supplied with power from a power source (not shown), and completes an initial operation for executing various operations. Display device 200 and digital pen 300 establish radio communication to each other by using a radio communication pairing technique. This makes it possible to perform communication from transmitter 370 of digital pen 300 to receiver 230 of display device 200.

Next, an operation of digital pen 300 will be described with reference to FIG. 8.

S800—Pen-side microcomputer 360 of digital pen 300 controls pressure sensor 330 to detect a pressure of pen nib 320. Pressure sensor 330 detects the pressure. If a pressure is detected by pressure sensor 330 (if “Yes”), the process proceeds to step S810, and, if any pressure is not detected by pressure sensor 330 if “No”), the process returns to step S800.

S810—Pen-side microcomputer 360 determines that the user is inputting a character or the like to display panel 210 of display device 200 with the digital pen, and instructs irradiator 380 to emit infrared light.

A dot pattern at a position of pen nib 320 is detected by objective lens 340 and image sensor 350. Here, the infrared light emitted from irradiator 380 is diffusely reflected at liquid crystal panel 219 or bezel decoration layer 215, and a part of the infrared light returns to digital pen 300.

When pen nib 320 of digital pen 300 is pointing a position on display part 210a of display panel 210, there are PET film 213, dot planarization layer 214, decoration planarization layer 217, touch sensor glass 218 and liquid crystal panel 219 in the direction in which the infrared light is emitted. Most of the infrared light transmits through PET film 213, dot planarization layer 214, decoration planarization layer 217 and touch sensor glass 218, because these layers are made of materials that transmit the infrared light. On the other hand, liquid crystal panel 219 is provided on its surface with a diffuse reflection sheet, the emitted infrared light is diffusely reflected on liquid crystal panel 219. As a result, a part of the infrared light emitted to display part 210a from digital pen 300 returns to digital pen 300.

When pen nib 320 of digital pen 300 is pointing a position on bezel part 210b of display panel 210, there are PET film 213, dot planarization layer 214 and bezel decoration layer 215 in the direction in which the infrared light is emitted. Most of the infrared light transmits through PET film 213 and dot planarization layer 214, because these layers are made of materials that transmit the infrared light. On the other hand, bezel decoration layer 215 diffusely reflects the infrared light. Consequently, a part of the infrared light emitted to bezel part 210b from digital pen 300 returns to digital pen 300.

In each of display part 210a and bezel part 210b, almost all of the infrared light coming back to digital pen 300 does not transmit dots 212 of the dot pattern. Infrared light rays that reach objective lens 340 are mainly the infrared light rays having passed through the areas between dots 212. The infrared light is received by image sensor 350 through objective lens 340. Objective lens 340 is disposed so as to receive reflected light from a position on display panel 210 which is pointed by pen nib 320. As a result, an image of a dot pattern at the position on the surface of display panel 210 which is pointed by pen nib 320 is captured by image sensor 350. In this manner, the dot pattern is optically read by objective lens 340 and image sensor 350. An image signal produced from an image captured by image sensor 350 is transmitted to pen-side microcomputer 360.

S820—Next, pen-side microcomputer 360 obtains a pattern shape of the dot pattern from the received image signal, and identifies a position of pen nib 320 on display panel 210 based on the pattern shape.

S830—Pen-side microcomputer 360 transmits the identified position through transmitter 370 to display device 200. This allows display device 200 to recognize the position of pen nib 320 of digital pen 300.

Next, an operation of display device 200 will be described with reference to FIG. 9. The position information transmitted from digital pen 300 is received by receiver 230 of display device 200. The received position information is transmitted from receiver 230 to display-side microcomputer 240.

S900—Display-side microcomputer 240 detects whether or not position information has been received. If any position information has not been received (if “No”), the process returns to step S900, and, if position information has been received (if “Yes”), the process proceeds to step S910.

S910—It is determined whether the received position information indicates a position on display part 210a or a position on bezel part 210b. If the received position information indicates a position on display part 210a (if “Yes”), the process proceeds to step S920, and, if the received position information indicates a position on bezel part 210b (if “No”), the process proceeds to step S930.

S920—Display-side microcomputer 240 controls display panel 210 to execute a display operation corresponding to display part 210a. Specifically, display-side microcomputer 240 controls display panel 210 so as to change a displayed content at a position corresponding to the position information on the display area of display panel 210. Since the case described in the present exemplary embodiment is a character input operation, a point is displayed at the position corresponding to the position information on the display area of display panel 210. In a case where the pen input with digital pen 300 is being continued, display-side microcomputer 240 continuously acquires the position information. With this operation, points can be continuously displayed at positions of pen nib 320 on the display area of display panel 210 so as to follow a movement of pen nib 320 of digital pen 300. In other words, a character corresponding to a locus of pen nib 320 of digital pen 300 can be displayed on display panel 210.

S930—Display-side microcomputer 240 controls display panel 210 to execute a display operation corresponding to bezel part 210b. Specifically, display-side microcomputer 240 recognizes that the acquired position information indicates bezel part 210b, and controls display panel 210 so as to perform such operations, for example, as displaying a menu or changing the screen based on the specifications of the operating system. In the case of displaying a menu, the menu is displayed in display part 210a of display panel 210.

If pressure sensor 330 does not detect a pressure for at least a predetermined period of time in step S900, pen-side microcomputer 360 determines that the pen input by the user is not continued, and ends the processing. Also, pen-side microcomputer 360 stops transmission of position information to display-side microcomputer 240. This allows display-side microcomputer 240 to recognize that the pen input is not continued. Then, display-side microcomputer 240 also stops its processing.

Although the case of writing a character on display part 210a has been described in the above, use of display control system 100 is not limited to this case. It is of course possible to write symbols, graphics and the like, in addition to characters and numerals. It is also possible to use digital pen 300 like an eraser to erase characters, graphics and the like displayed on display panel 210. Further, it is possible to use digital pen 300 like a mouse to move a cursor displayed on display panel 210 or to select an icon displayed on display panel 210. In other words, it is possible to use digital pen 300 to operate a graphical user interface (GUI).

In display control system 100, as described above, an input to display device 200 can be performed according to a position on display panel 210 directed by digital pen 300, and display device 200 can perform various display controls according to the input.

### 4. Advantageous Effects and Others

As described above, it is possible to make less noticeable the position information patters at the bezel part, so that it is possible to increase the color variations of the bezel part while maintaining the accuracy of reading the position information patterns in the bezel part with the digital pen as a reader.

In the above, the present exemplary embodiment has been described as an example of the present disclosure. However, the techniques according to the present disclosure are not limited to the present exemplary embodiment, and may be applied to other exemplary embodiments in which modifications, substitutions, additions or omissions are appropriately made.

For example, although a case of using the dot patterns as position information patterns has described above, the position information patterns may not be limited to the dot patterns. Instead of using dots, position information patterns may be formed by regularly arranging predetermined marks. For example, pixel block patterns may be used.

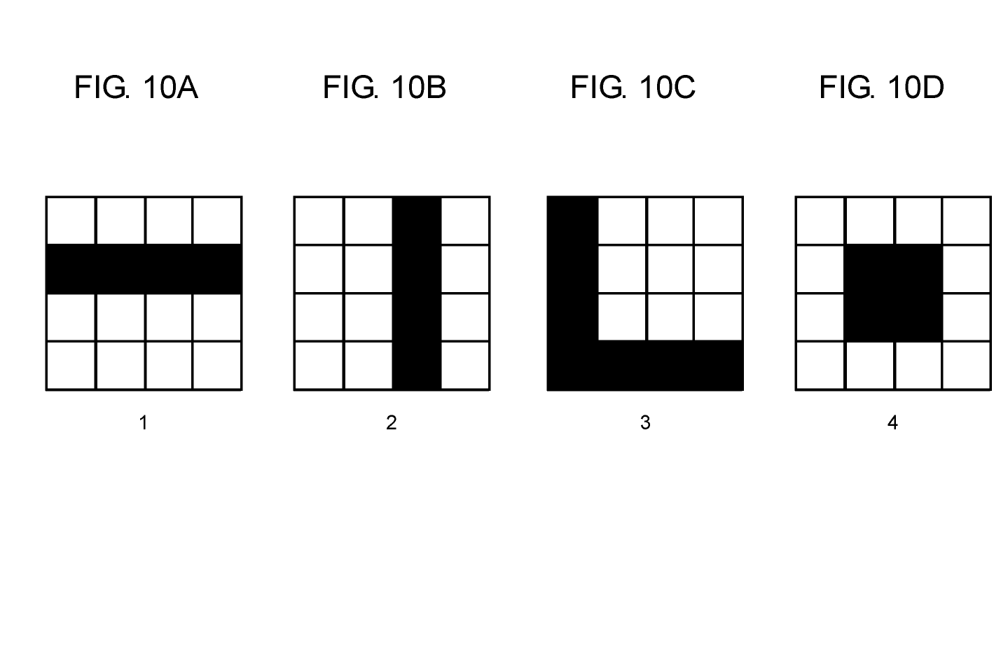

FIG. 10A is a first diagram for explaining a pixel block pattern, FIG. 10B is a second diagram for explaining a pixel block pattern, FIG. 10C is a third diagram for explaining a pixel block pattern, and FIG. 10D is a fourth diagram for explaining a pixel block pattern. In optical film 211, pixel block patterns as shown in FIG. 10A, FIG. 10B, FIG. 10C and FIG. 10D, for example, may be defined so that digital pen 300 can discriminate them as different pieces of information from one other. The pattern shown in FIG. 10A is numerically expressed as “1”. The pattern shown in FIG. 10B is numerically expressed as “2”. The pattern shown in FIG. 10C is numerically expressed as “3”. The pattern shown in FIG. 10D is numerically expressed as “4”. The area occupied by the pixel block patterns per each unit area of bezel part 210b may be made smaller than the area occupied by the pixel block patterns per each unit area of display part 210a. The pixel block patterns may be defined such that the same pattern can be identified as the same information by digital pen 300 even if the area occupied by the pixel block patterns is changed.

In the manners as described above, even if the dot patterns or the pixel block patterns are used as position information patterns, and the color of bezel part 210b is made a relatively thin color such, for example, as white, it is possible to make the position information patterns less noticeable to the user's eye. As a result, it is possible to increase the color variations of the bezel surface while maintaining the accuracy of reading the position information patterns in bezel part 210b with digital pen 300.

The present disclosure is applicable to optical films, display panels, display devices, and the like.

What is claimed is:

1. An optical film comprising:
a display part; and
a bezel part formed around the display part,
wherein each of the display part and the bezel part has formed therein patterns indicating position information, and
wherein an area occupied by the patterns per a unit area in the bezel part is smaller than an area occupied by the patterns per a unit area in the display part.

2. The optical film according to claim 1,
wherein the patterns are dot patterns, and
wherein a size of each of dots configuring the dot patterns in the bezel part is smaller than a size of each of dots configuring the dot patterns in the display part.

3. The optical film according to claim 2,
wherein a distance between adjacent dots in the bezel part is equal to a distance between adjacent dots in the display part.

4. The optical film according to claim 1,
wherein the patterns are pixel block patterns, and
wherein an area occupied by the pixel block patterns per a unit area in the bezel part is smaller than an area occupied by the pixel block patterns per a unit area in the display part.

5. A display panel comprising:
a panel that displays an image; and
the optical film according to claim 1 provided on the panel.

6. A display device comprising:
the display panel according to claim 5;
a receiver that receives position information of the patterns detected by a reader, the pattern being produced in the display part; and
a display-side microcomputer that controls a content to be displayed on the display panel based on the position information received by the receiver.
